(19) United States
(12) Patent Application Publication
(10) Pub. No.: US 2006/0286936 A1
(43) Pub. Date: Dec. 21, 2006

(54) Method for trasmitting data between an emitter and a receiver which are interconnected by means of an intermidiate device

(75) Inventor: Mathieu Langlais, LANNION (FR)

Correspondence Address: LOWE HAUPTMAN BERNER, LLP, 1700 DIAGONAL ROAD, SUITE 300, ALEXANDRIA, VA, 22314, US

(73) Assignee: FRANCE TELECOM SA, PARIS (FR)

(21) Appl. No.: 10/564,765

(22) PCT Filed: Jul. 8, 2004
(86) PCT No.: PCT/EP04/07600

§ 371 Date: Jun. 28, 2006

(30) Foreign Application Priority Data
Jul. 17, 2003 (FR) 0308760

(51) Int. Cl. H04B 7/00

(52) U.S. Cl. 455/66.1

(57) ABSTRACT

A transmitter and receiver are connected together via an intermediate device including a controller for managing a signaling port able to (a) receive connection authorization requests and to deliver such authorizations, and (b) manage a listening port to which the transmitter and receiver are able to be connected after having been so authorized by the intermediate device. The intermediate device configures a default access mode, in which the intermediate device can authorize any connection to the listening port. The transmitter stores an address peculiar to the listening port to which the transmitter is connected.

The present invention concerns a method of transmitting data in a telecommunications system including a transmitter and a receiver intended to be connected together via an intermediate device including control means intended to provide management of at least one signalling port able to receive connection authorisation requests and to deliver such authorisations on the one hand, and to provide management of at least one listening port to which the transmitter and receiver are able to be connected after having been authorised for this by the intermediate device on the other hand.

Such methods are normally used for implementing point to point connections, for example in telephony applications via a mesh network of the Internet type. In an application of this type, the transmitter and receiver usually consist of servers connected to a wired communication network and are connected together via the intermediate device by means of the said mesh network. The transmitter and receiver therefore each serve as a gateway between the wired domain and the meshed domain, so that they are often designated by the term “gateway”. In such applications, the initiation of a communication between the transmitter and receiver is controlled by the intermediate device, in particular by means for managing its authorisation port, so that the device is often designated by the term “gatekeeper”.

In the applications described above, initiating a communication from a transmitter with a receiver requires the execution of a certain number of steps defined by a standardised communication protocol, for example the H.323 protocol defined by a recommendation of the ITU (the abbreviation known to persons skilled in the art by the term “International Telecommunication Union”). According to this protocol, in order to put them in communication with each other, the transmitter and receiver must individually request to the intermediate device an authorisation to connect to the said device. No call can be transmitted by the transmitter, nor received by the receiver, before the said transmitter or the said receiver has received such a connection authorisation, which authorisation will in principle comprise an address of a listening port of the intermediate device to which the transmitter and receiver will have to connect in order to be put in communication. After reception of its connection authorisation, the transmitter will be able to send a call message to the said address of the listening port, which will retransmit the said call message to the receiver according to a procedure defined in detail in the H.323 protocol, and which generally involves two exchanges each of four messages between the transmitter and the intermediate device on the one hand and between the receiver and the intermediate device on the other hand. It is therefore found that, before each call, two exchanges each of two messages are necessary for the connection authorisations between the transmitter and the intermediate device on the one hand and between the receiver and the intermediate device on the other hand. The exchanges necessary solely for the connection authorisations therefore represent approximately one third of a volume of protocol communication generated by the implementation of the H.323 protocol, which is added to the volume of data which will be transmitted when the transmitter and receiver will actually be connected to each other. The volume of protocol communication has a not insignificant influence on the volume of data that the telecommunication system is able to process at any time, since this volume of protocol communication mobilises resources which will not be able to be used for transmitting data proper, and therefore limits the performance of the system.

One of the aims of the invention is to reduce the protocol communication volume generated when a transmitter is put in communication with a receiver by an intermediate device, by proposing a method in which the management of the authorisations for connection to the said intermediate device is simplified.

In fact, a method in accordance with the introductory paragraph is characterised according to the invention in that it includes:
a step for configuring the intermediate device in a so-called default access authorisation mode, in which the said intermediate device is deemed to authorise any connection to the said listening port, and
a step for connecting the transmitter and receiver to the said listening port.

The invention in some way makes it possible to short-circuit the signalling port by configuring the intermediate device in default access authorisation mode, so that the exchanges of messages necessary for the connection authorisations are no longer required for effecting a connection between the transmitter and receiver, which reduces the protocol communication volume by approximately one-third compared with the volume generated by the implementation described above of a conventional protocol.

Various means can be employed for enabling the transmitter and receiver to identify the listening port to which they must connect. According to a particular embodiment in the invention, a method as described above also includes a step for storing by the transmitter an address peculiar to the listening port to which the transmitter is intended to be connected.

The address peculiar to the listening port can be caused to vary according to the context in which the transmitter, the receiver and the intermediate device are situated within the telecommunication system. In many applications, the intermediate device will have available several listening ports to which many transmitters and receivers will be able to connect, so that the intermediate device will have to provide dynamic management of existing ports in order for example to harmoniously distribute the communication volumes on the said listening ports.

The invention as defined above thus optimises dynamic management of a multiplicity of listening ports, by allowing a flexible modification of the address of the listening port to which a given transmitter is supposed to connect.

The control means occupy a central position which offers the advantage of making them able to centralise the management of information relating to the operating conditions of the listening ports, and of the transmitters, receivers and any peripheral devices connected to the said listening ports. Such a central position confers on the control means an overall view of the operating conditions of the system and enables the said control means to provide a coherent management of the information thus connected.

In such an application, a method as described above will advantageously include a prior step of transmission, by the intermediate device, of the said address peculiar to the listening port to which the transmitter is intended to be connected. These transmission means will enable the intermediate device to choose dynamically the listening port that is to provide the connection between the transmitter and the receiver, and to effectively designate this port to the said transmitter.

According to one of its hardware aspects, the invention also concerns a telecommunication system including a transmitter and receiver intended to be connected together via an intermediate device including control means intended to provide management of at least one signalling port able on the one hand to receive connection authorisation requests and to deliver such authorisations, and on the other hand to provide management of at least one listening port to which the transmitter and receiver are able to be connected after having been authorised for this by the intermediate device, a system in which the intermediate device includes means of configuring in a so-called default access mode, in which the said intermediate device is deemed to authorise any connection to the said listening port, the transmitter also including means for storing an address peculiar to the listening port to which the said transmitter is intended to be connected.

According to another particular embodiment of the invention, which can be implemented alternatively or cumulatively with the previous one, the intermediate device includes means for transmitting the said address peculiar to the listening port to which the transmitter is intended to be connected.

The signalling and listening ports can each be included in a device physically isolated from the others and able to communicate with control means, which may themselves be separate from the said ports. Alternatively, the signalling and listening ports, and their control means, can be collected together within a single device.

The invention also concerns, as a means useful for its implementation, a server able to fulfil the functions of an intermediate device included in a telecommunication system according to the above description.

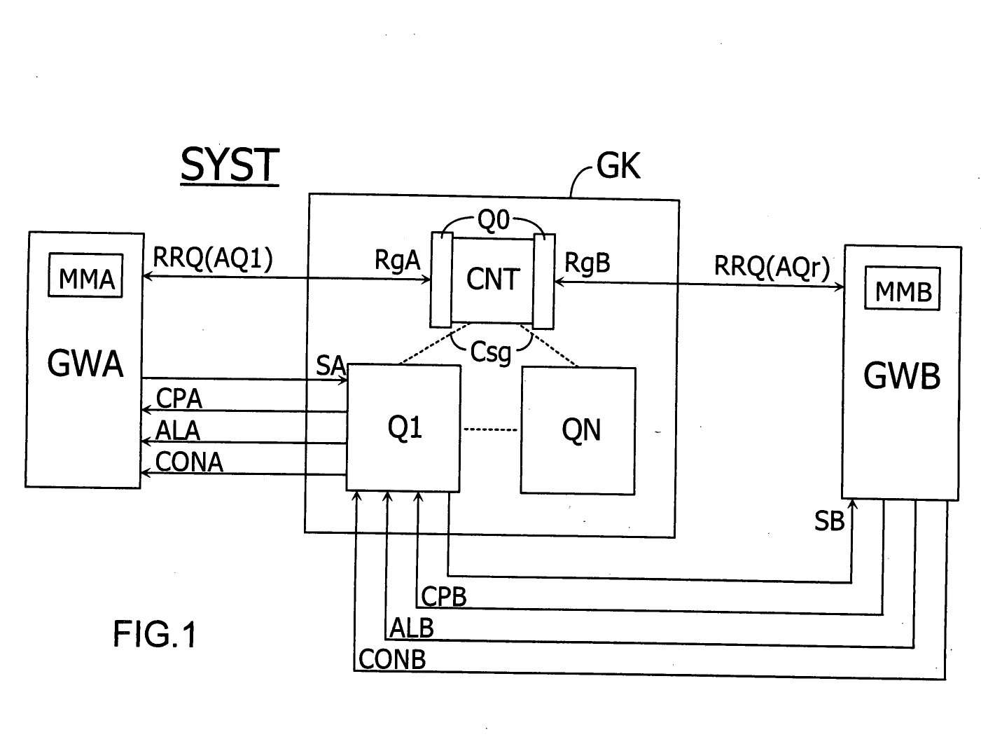

The characteristics of the invention mentioned above, as well as others, will emerge more clearly from a reading of the following description of an example embodiment, the said description being given in relation to FIG. 1, which depicts a telecommunication system in which the invention is implemented.

FIG. 1 depicts a telecommunications system SYST according to the invention which includes a transmitter GWA and a receiver GWB intended to be connected together via an intermediate device GK including control means CNT intended to provide management of at least one signalling port Q0 able on the one hand to receive connection authorisation requests and to deliver such authorisations, and on the other hand in this example to provide management of a plurality of listening ports Q1 . . . QN to which the transmitter GWA and receiver GWB are able to be connected after having been authorised for this by the intermediate device GK.

In this system SYST, the intermediate device GK includes means of configuring in a so-called default access authorisation mode, in which the said intermediate device GK is deemed to authorise any connection to one of its listening ports Q1 . . . QN.

It will thus suffice for the transmitter GWA to send, to the listening port Q1, a call message SA containing information which, after having been transmitted to the control means CNT in the form of one or more messages taking a control path Csg, will enable the said control means CNT to identify the receiver GWB for which the intermediate device GK is transmitting a call message SB to the said receiver GWB and thus initiate a connection between the transmitter GWA and the receiver GWB. Call messages will for example be in accordance with the protocol Q.931 defined by the ITU.

In the example embodiment of the invention described here, which illustrates the establishment of a simple call, the transmitter GWA and receiver GWB will then proceed with an exchange of messages via the listening port Q1, an exchange of messages which is defined by the protocol H.323 mentioned above:

The receiver GWB will, after reception of the call message SB, said a call reception message CPB which will be passed on by the listening port Q1 to the transmitter GWA in the form of a message CPA, following which the said receiver GWB will send an alert message ALB which will be passed on by the listening port Q1 to the transmitter GWA in the form of a message ALA, the said receiver GWB then sending a connection confirmation message CONB which will be passed on by the listening port Q1 to the transmitter GWA in the form of a message CONA. The connection between the transmitter GWA and the receiver GWB will then be deemed to be effectively established, and the said transmitter GWA and the said receiver GWB will be able to exchange, in routed mode or in direct mode, messages for example in accordance with a protocol H.245 defining the nature of the data intended to be transmitted, which data will for example be able to convey a voice signal in the context of a point-to-point telephony application via a mesh network which will have served as a means of transmitting messages exchanged between the transmitter GWA and the intermediate device GK on the one hand, and between the intermediate device GK and the receiver GWB on the other hand.

According to the conventional data transmission methods of the aforementioned H.323 type, a connection between the transmitter GWA and the receiver GWB can be achieved in principle only after the transmitter GWA and the receiver GWB have sent a connection authorisation request and received such authorisation, which requires two exchanges each of two messages, that is to say four additional protocol messages for the establishment of each connection between a transmitter and a receiver. The present invention in some way makes it possible to short-circuit the signalling port Q0 by configuring the intermediate device GK in default access authorisation mode, which reduces by one third the protocol communication volume compared with the volume generated by the use described above of a conventional protocol of the H.323 type.

In the embodiment of the invention described here, the control means CNT are able to analyse, by means of messages following the control paths Csg, the communication volumes borne by the listening ports Q1 . . . QN. This control means CNT can thus distribute harmoniously on these listening ports Q1 . . . QN the load represented by these volumes, and showing a dynamic management of the address Aqj of the listening ports Qj (for j=1 to N) allocated by the intermediate device GK to the connections between the various transmitters and receivers that the intermediate device GK is intended to connect to one another. To this end, the intermediate device GK includes means of transmitting at least one address, in this example AQ1, peculiar to the listening port Q1, which the control means CNT have selected with a view to a connection with the transmitter GWA.

The transmission means, which include here the signalling port Q0, are also able to transmit to the receiver GWB an address AQr, which can be identical or not to the address AQ1, the said address AQr identifying a listening port Qr to which the receiver GWB will have to connect in a situation (not shown here) where it will fulfil the role of a transmitter.

In the example depicted here, the addresses AQ1 and AQr are communicated to the transmitter GWA and to the receiver GWB during the execution of a prior installation step during which the said transmitter GWA and the said receiver GWB are intended to indicate their existence by identifying themselves to the intermediate device GK by means of registration requests RgA and RgB received by the intermediate device GK on its signalling port Q1. In response to the registration request RgA, the intermediate device GK will send to the transmitter GWA, via the said signalling port Q0, an acknowledgement of receipt of registration RRQ(AQ1) including the said address AQ1 of the listening port Q1. In response to the registration request RgB, the intermediate device GK will send to the receiver GWB, via the signalling port Q0, an acknowledgement of receipt of registration RRQ(AQr) including the said address AQr of the listening port Qr. These addresses AQ1 and AQr can then be stored by the transmitter GWA and by the receiver GWB in storage means MMA and MMB, with a view to being used by this transmitter GWA and by this receiver GWB in order to identify and designate the destination of the messages that they will be called on to transmit subsequently. It must of course be understood that, by virtue of the present invention, the control means CNT can modify over time the addresses of the listening ports intended to be used by the transmitter GWA and by the receiver GWB according to the communication volumes borne by the various listening ports Q1 . . . QN, so as to harmoniously distribute the said volumes on the said ports. Such modifications will then be controlled by the control means CNT by means of information messages similar to the messages RRQ(AQ1) and RRQ(AQr) described above, which the control means CNT can send, possibly during communication, to the various transmitters and receivers concerned at the time in question.

1. Method of transmitting data in a telecommunications system including a transmitter and a receiver adapted to be coupled together via an intermediate device including a controller arrangement for managing (a) at least one signalling port able to receive coupling authorization requests and to deliver such authorizations, and (b) at least one listening port to which the transmitter and receiver are able to be coupled after having been so authorized by the intermediate device, the method including:
configuring the intermediate device in a default access authorization mode, in which the intermediate device can authorize any coupling to the listening port, and
coupling the transmitter and receiver to the listening port.

2. Method according to claim 1, wherein the intermediate device, prior to transmission, has loaded therein the address of the listening port to which the transmitter is intended to be coupled.

3. Telecommunication system including a transmitter and receiver adapted to be coupled together via an intermediate device including a controller arrangement for managing at least one signalling port able to (a) receive coupling authorization requests and to deliver such authorizations, and (b) manage at least one listening port to which the transmitter and receiver are able to be coupled after having been so authorized by the intermediate device, the intermediate device being arranged for configuring default access mode, in which the intermediate device is deemed to authorize any coupling to the listening port; the transmitter being arranged for storing an address peculiar to the listening port to which the transmitter is intended to be coupled.

4. Telecommunication system according to claim 3, wherein the intermediate device is arranged for transmitting the address peculiar to the listening port to which the transmitter is intended to be coupled.

5. A server for performing the functions of the intermediate device included in the telecommunication system of claim 4.

6. A server for performing the functions of the intermediate device included in the telecommunication system of claim 3.

7. An intermediate device for a telecommunication system including a transmitter and receiver adapted to be coupled together via the intermediate device, the transmitter being arranged for storing an address peculiar to a listening port to which the transmitter is intended to be coupled, the intermediate device including a controller arrangement for managing at least one signaling port able to (a) receive coupling authorization requests and to deliver such authorizations, and (b) manage at least one listening port to which the transmitter and receiver are able to be coupled after having been so authorized by the intermediate device, the intermediate device being arranged for configuring a default access mode, in which the intermediate device is deemed to authorize any coupling to the listening port.

8. An intermediate device according to claim 7, wherein the intermediate device is arranged for transmitting the address peculiar to the listening port to which the transmitter is intended to be coupled.

9. A server for performing the functions of the intermediate device of claim 7.

10. A server for performing the functions of the intermediate device of claim 8.
